(19) United States
(12) Patent Application Publication
(10) Pub. No.: US 2026/0154840 A1
(43) Pub. Date: Jun. 4, 2026

(54) Artificial Intelligence-Assisted Radiographic Detection and Classification of Leadless Implanted Electronic Devices

(71) Applicant: Mayo Foundation for Medical Education and Research, Rochester, MN (US)

(72) Inventors: Richard D. White, Ponte Vedra Beach, FL (US); Mutlu Demirer, St. Johns, FL (US); Barbaros S. Erdal, Jacksonsville, FL (US); Vikash Gupta, Jacksonville, FL (US); Fred Kusumoto, Ponte Vedra, FL (US); Ronnie A. Sebro, Jacksonville, FL (US)

(21) Appl. No.: 18/685,848

(22) PCT Filed: Aug. 24, 2022
(86) PCT No.: PCT/US2022/041382

§ 371 Date: Feb. 22, 2024

Related U.S. Application Data
(60) Provisional application No. 63/236,602, filed on Aug. 24, 2021.

(51) Int. Cl. G06T 7/70; G06N 3/0464; G06V 10/25; G06V 10/764; G06V 10/82

(52) U.S. Cl. CPC G06T 7/70; G06N 3/0464; G06V 10/25; G06V 10/764; G06V 10/82; G06T 2207/10116; G06V 2201/034

(57) ABSTRACT

Systems and methods for artificial intelligence (“AI”)-assisted radiographic detection of leadless implanted electronic devices (“LLIEDs”) are provided. In general, AI systems and methods are constructed and implemented to provide a highly accurate C model that can assist physicians and support personnel with radiographic (e.g., chest x-ray) detection of the presence (or absence) of any LLIED, and the localization of any detected LLIED(s), prior to performing a scheduled or emergency MRI examination. A two-tier cascading neural network methodology is used to detect the locations of LLIEDs in the first tier and to classify or otherwise identify the type of detected LLIEDs in the second tier.

### BACKGROUND

Implantation of small lead-less devices into the chest for cardiac pacing, monitoring of heart electrical activity, central circulatory pressure measurement, or non-cardiovascular chemical assessment (e.g., within esophageal fluid) is now common. Awareness of the presence, location, and specific type, of such Lead-Less Implanted Electronic Devices (“LLIEDs”) in the chest is important to patient safety, device function, clinical support operations and/or local environmental hazard. This need for LLIED recognition is particularly true as related to the increased frequency of exposures to more and more demanding magnetic resonance imaging (“MRI”) environments (e.g., 3 or 7 Tesla field strengths). Although several specific LLIEDs are considered “MRI-conditional” (i.e., posing no hazards with specified MRI environments and conditions of use), it remains imperative to acknowledge that MRI-conditional does not mean MRI-compatible, and not all MRI-conditional devices are of equal potential risk (partly related to presence of other implants). Even when considered MRI-conditional, MRI exposure potentially results in recordable patient-related effects from the LLIED or cause measurable changes in LLIED function. Some MRI-conditional LLIEDs still require device-specific patient and/or LLIED assessment or preparation before, during, or after an MRI examination, thereby creating new operational prerequisites (e.g., coordination between Radiology and Cardiology services). Some LLIEDs are also considered to be more conditionally restrictive than others, and some LLIEDs are considered to be “MRI unsafe” (i.e., posing a risk in all MRI environments).

A chest x-ray is a standard component of pre-MRI safety screening for LLIEDs or other man-made implants (e.g., retained permanent pacing wires) or foreign objects (e.g., bullets, retained surgical items) in the chest. Such chest x-ray-based screening assumes greater importance in the absence of adequate patient records. Unfortunately, any of the LLIEDs could be overlooked on chest x-ray or fluoroscopic images due to their small sizes (comparable to a AAA battery), obscuration by other external or internal metallic or electronic materials, suboptimal radiographic technique (e.g., due to patient confinement to a bed), or patient-related factors (e.g., patient motion with image blurring).

Thus, there is a need for technology that supports radiographic detection/localization and identification of LLIEDs and addresses limitations of currently available radiologist-based (i.e., professional interpretation) or human-assisted (e.g., using decision algorithm) approaches.

### SUMMARY OF THE DISCLOSURE

The present disclosure addresses the aforementioned drawbacks by providing a method for detecting and identifying a leadless implanted electronic device in an x-ray image. The method includes accessing radiographic image data with a computer system, where the radiographic image data include at least one x-ray image of a subject potentially having at least one leadless implanted electronic device. A first and second trained neural network are accessed with the computer system. The first trained neural network having been trained on first training data to detect and localize a location of a leadless implanted electronic device in radiographic image data, and the second trained neural network having been trained on second training data to classify a type of leadless implanted electronic device detected in radiographic image data. The radiographic image data are applied to the first trained neural network using the computer system, generating output as detected leadless implanted electronic device data that indicate a location of the at least one leadless implanted electronic device in the radiographic image data. The detected leadless implanted electronic device data are applied to the second trained neural network using the computer system, generating output as classified leadless implanted electronic device data that identify a type of the at least one leadless implanted electronic device detected in the radiographic image data. At least one of the detected leadless implanted electronic device data or the classified leadless implanted electronic device data are then displayed to a user.

The foregoing and other aspects and advantages of the present disclosure will appear from the following description. In the description, reference is made to the accompanying drawings that form a part hereof, and in which there is shown by way of illustration a preferred embodiment. This embodiment does not necessarily represent the full scope of the invention, however, and reference is therefore made to the claims and herein for interpreting the scope of the invention.

### BRIEF DESCRIPTION OF THE DRAWINGS

FIG. 1 is a workflow of an example two-tier cascading neural network methodology for detecting, localizing, and identifying leadless implanted electronic devices (“LLIEDs”) in radiographic image data, such as chest x-rays or fluoroscopic images.

FIG. 2A illustrates example categories and types (including MRI-safety levels and other descriptive details) of LLIEDs that can be detected and classified using the described systems and methods. In this example, the sample LLIEDs can be used to form a 9-class model.

FIG. 2B illustrates example categories and types (including MRI-safety levels and other descriptive details) of LLIEDs that can be detected and classified using the described systems and methods. In this example, the sample LLIEDs can be used together with the sample LLIEDs shown in FIG. 2A to form a 12-class model.

FIG. 3 is a flowchart of an example method for detecting, localizing, and identifying LLIEDs in radiographic image data using a two-tier cascading neural network implementation.

FIG. 4 is a flowchart of an example process for training (and testing) neural networks and/or models for use in the two-tier cascading neural network/model implementation of FIG. 3.

FIG. 5 is a block diagram of an example system for detecting, localizing, and identifying LLIEDs in radiographic image data.

FIG. 6 is a block diagram of example components that can implement the system of FIG. 5.

### DETAILED DESCRIPTION

Described here are systems and methods for artificial intelligence (“AI”)-assisted radiographic detection and/or localization of leadless implanted electronic devices (“LLIEDs”). In general, AI systems and methods are constructed and implemented to provide one or more highly accurate models that can assist physicians and support personnel with radiographic (e.g., chest x-ray, fluoroscopy) detection of the presence, or not, of any LLIED and the localization of any such detected LLIED prior to performing a scheduled or emergency MRI examination. Further, the AI systems and methods can provide a specific identification of each LLIED in addition to detecting their presence.

The AI model(s) (e.g., neural networks and/or models) described in the present disclosure are capable of detecting and/or localizing one or more LLIEDs on chest x-ray (e.g., digital frontal P-A and/or A-P chest x-rays) or other radiographic images (e.g., fluoroscopic images) with significant sensitivity (e.g., at or near 100% detection and/or localization sensitivity). Additionally or alternatively, the AI model(s) are capable of identifying the specific type of detected and/or localized LLIED (and thus its MRI safety level and preparation/assessment needs) on the same radiographic image via a user-friendly graphical user interface and/or display. For example, the systems and methods described in the present disclosure are capable of detecting and/or localizing MRI-conditional loop recorders or right ventricular pacemakers, a more stringently-MRI-conditional pulmonary artery pressure monitor for heart failure, and an MRI-unsafe esophageal reflux pH-monitoring capsule on chest x-ray or other radiographic images.

The clinical application of the systems and methods implementing the AI models (e.g., neural networks and/or other AI or machine learning models) described in the present disclosure in order to assist in pre-MRI safety screening based on a chest x-ray or other radiographic image advantageously provides significant safety and operational benefits (e.g., especially when integrated with the electronic medical record (“EMR”) for LLIED recording and scheduling of appropriate pre- and post-MRI clearance as well as needed patient and/or LLIED assessment before and/or after the MRI examination, or needed monitoring during MRI scanning).

In general, the systems and methods described in the present disclosure implement a cascading neural network approach to detecting, localizing, and identifying (or otherwise classifying) LLIEDs in radiographic image data. In some implementations, the cascading neural network may be a classification-based cascading neural network. For example, a 2-tiered approach to AI model development is implemented by the described systems and methods. First, to emphasize the detection of the general presence (or absence) and location of any LLIED, and then second to support identification of the specific type of LLIED represented, if an LLIED had been detected and/or localized. This 2-tier approach can be implemented by a cascading neural network methodology.

The cascading neural network/model methodology for AI model development described in the present disclosure includes a first tier in which LLIEDs are detected and located within radiographic image data and then optionally displayed to a user (e.g., displayed together with or overlaid on the radiographic image data). As a non-limiting example, a Faster region-based convolutional neural network (“R-CNN”) approach or other detection/localization approaches (e.g., YOLO) can be used. The desired reduction in probability threshold required to detect and/or localize all LLIEDs may produce multiple generated bounding boxes (“GBBs”), which can, in some implementations, be compensated for by combined size/shape-based filtering and by the strength of the multi-classifier in the second tier classification processing. In the second tier, a multi-class CNN (e.g., an Inception V3-based multi-class CNN) can be used as a multi-classifier to achieve very high identification accuracies of a known (i.e., previously classified by a within a model) and previously detected and/or localized LLIEDs.

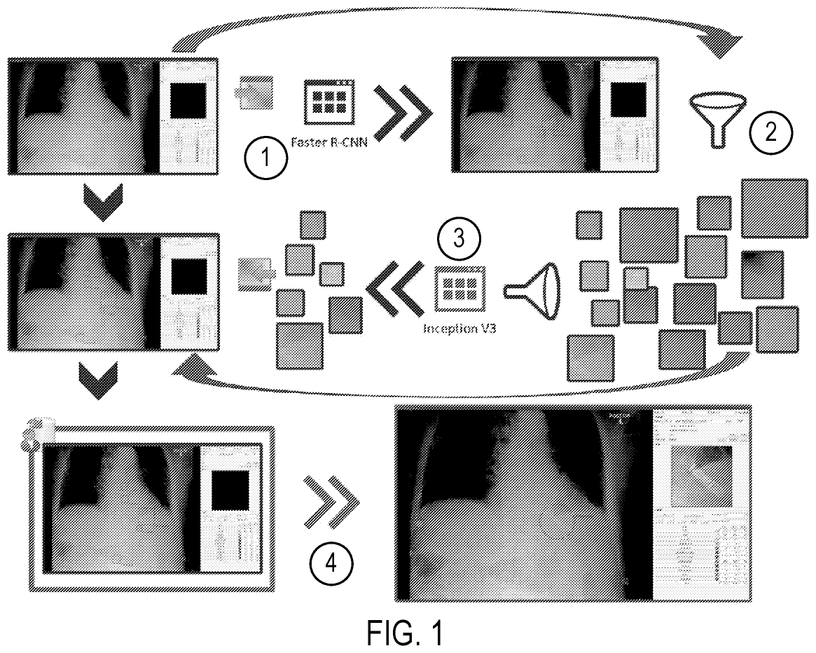

An example workflow for such a cascading neural network/model approach is shown in FIG. 1. In the illustrated embodiment, a simulated user-experience is depicted on a local graphical user interface (“GUI”) with a client application of the two-tier cascading methodology. Users can directly review source frontal chest x-ray or other radiographic images (e.g., fluoroscopic images) before and/or after AI model inference feedback to the end-user (e.g., via the GUI). At step 1, first, source images are transferred to a Faster R-CNN model which produces candidate detection/localization GBBs (Tier 1); the trained and tested Faster R-CNN-based model also applies combined size/shape-based filters and non-max suppression to the GBBs prior to output to reduce the number of errant GBBs. At step 2, based on the Faster-RCNN output, ROIs can be created (e.g., GBBs define borders for the cropped ROIs). At step 3, potentially accurate GBBs are transferred to an Inception V3-based model for LLIED-type identification (Tier 2); this model also acts as a filter and identifies the most valid GBBs to be displayed (along with labels) as potential LLIEDs to the end-users. At step 4, end-users can adjudicate the AI inference results and confirm the presence and location, as well as accept, reject, modify (e.g., with relabeling), or establish (e.g., with new labeled ROIs) the identity of LLIED types to support both clinical decision support, as well as continuous learning and modernization of the model for ongoing real-world adaptation. All user interactions can be captured to refine the models as part of continuous learning, including modernization with inclusion (e.g., additional detection/localization and identification) of new LLIED types.

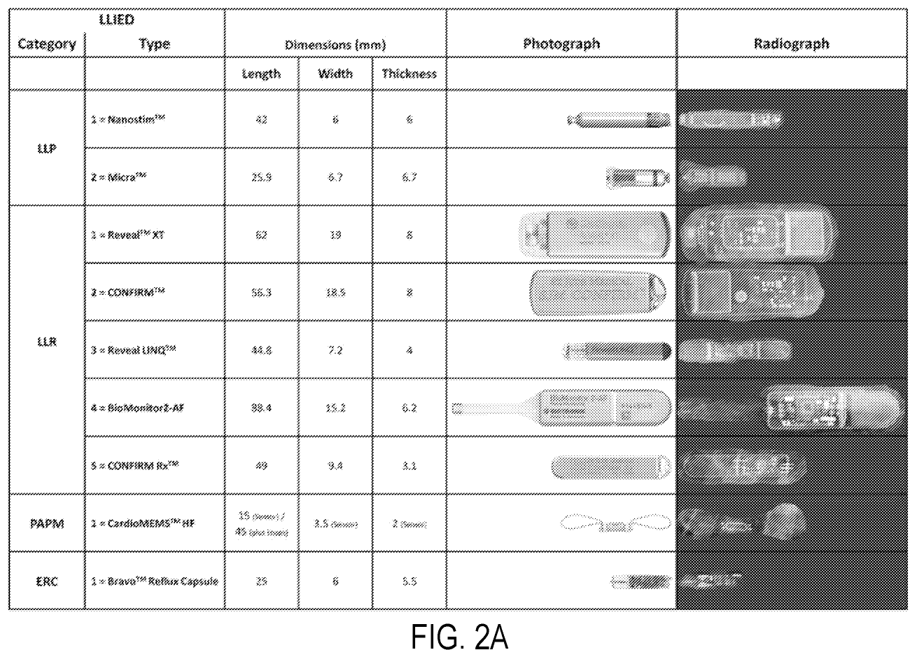

FIG. 2A illustrates example categories and types (including MRI-safety levels and other descriptive details) of LLIEDs that can be detected, localized, and identified using the described systems and methods. The LLIEDs shown in FIG. 2A can be used as the foundation for a 9-class LLIED model. FIG. 2B illustrates additional example categories and types (including MRI-safety levels and other descriptive details) of LLIEDs that can be detected, localized, and identified using the described systems and methods. Together, the LLIEDs shown in FIG. 2A and FIG. 2B can be used as the foundation for a 12-class LLIED model. It will be further appreciated that LLIEDs other than those shown in FIGS. 2A and 2B can also be used when constructing an LLIED classification model. Further, different combinations of the LLIEDs shown in FIGS. 2A and 2B can also be used to construct different models than the 9-class and 12-class models mentioned above.

Advantageously, the 2-tier cascading neural network/model methodology described in the present disclosure addresses several recently FDA-endorsed actions, including: the “Predetermined Change Control Plan” (e.g., Algorithm Change Protocol for how a model will learn and change while remaining safe and effective), and “Real-world Performance” monitoring (e.g., seamless gathering and validation of relevant real-world parameters and ongoing collection of performance data). To these ends, the systems and methods described in the present disclosure can present AI-inference results in a meaningful and user-friendly fashion (e.g., rapid return of results, uncomplicated display), facilitating their utilization by the physicians conducting the radiographic image data interpretation when deemed ethical, appropriate, and beneficial to patients. Advantageously, the systems and methods described in the present disclosure allow for “ground-truth” users (e.g., radiologist or other physicians) to prospectively adjudicate (i.e., fully accept, fully reject, or modify) the AI-inference results in order to assist in radiologic interpretation and reporting and/or to reinforce the essential continuous-learning improvement and modernization of the two AI neural networks/models.

A user-friendly AI inference output for an end-user can thus be generated and displayed to a user to provide an interactive viewer (e.g., a GUI) for radiographic image (e.g., chest x-ray or fluoroscopy) display, presentation of geographically coordinated AI-model inference results in a conventional style, and easy user indication of their “ground-truth” judgment on the results for clinical decision support, as well as continuous learning and modernization of the model for ongoing real-world adaptation.

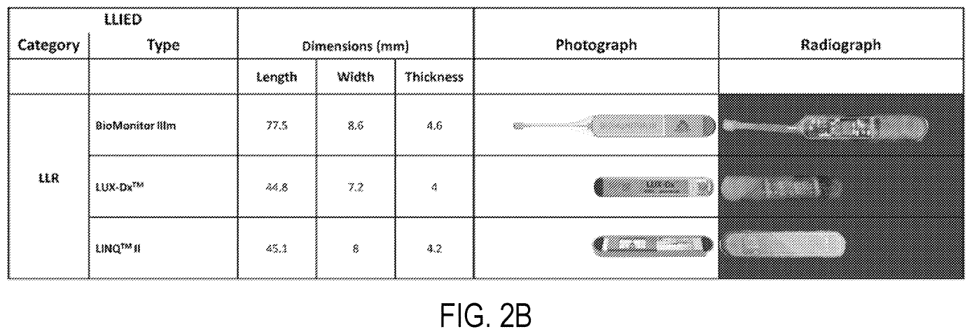

Referring now to FIG. 3, a flowchart is illustrated as setting forth the steps of an example method for detecting/localizing LLIEDs and/or identifying the type of detected LLIED(s) in radiographic image data using suitably trained neural networks or other machine learning algorithms or AI models or algorithms.

The method includes accessing radiographic image data (e.g., digital radiographic image data) with a computer system, as indicated at step 302. Accessing the radiographic image data may include retrieving such data from a memory or other suitable data storage device or medium. Alternatively, accessing the radiographic image data may include acquiring such data with an x-ray imaging system and transferring or otherwise communicating the data to the computer system, which may be a part of the x-ray imaging system.

Trained neural networks (or other suitable machine learning algorithms and/or AI models or algorithms) are then accessed with the computer system, as indicated at step 304. Accessing the trained neural networks may include accessing network parameters (e.g., weights, biases, or both) that have been optimized or otherwise estimated by training the neural networks on training data. In some instances, retrieving the neural networks can also include retrieving, constructing, or otherwise accessing the particular neural network architecture(s) to be implemented. For instance, data pertaining to the layers in the neural network architecture(s) (e.g., number of layers, type of layers, ordering of layers, connections between layers, hyperparameters for layers) may be retrieved, selected, constructed, or otherwise accessed.

In general, the neural networks/models are trained, or have been trained, on training data in order to detect and/or localize an LLIED in radiographic image data, such as chest x-ray images, generating output as detected and/or localized LLIED data, and to identify and/or classify the type of LLIED in the detected/localized LLIED data, generating output as LLIED identification data.

In general, more than one trained neural network may be accessed. For example, a first neural network may have been trained (e.g., on a first set of training data) to generate first feature data (e.g., pixels or regions indicating the detected location of an LLIED) that indicate the detection (e.g., presence or absence) and location of an LLIED in radiographic image data, and a second neural network may have been trained (e.g., on the same or a second set of training data) to generate second feature data (e.g., pixels, regions) that result in specific LLIED-type classification, such as for identification, including MRI-safety level. Additionally or alternatively, the first and second neural networks can include first and second tiers of cascading neural networks.

For the detection/localization of LLIED-related pixels ROIs, a region-based convolutional neural network (“R-CNN”) can be used. As a non-limiting example, a Faster R-CNN ResNet-50 FPN can be selected as the base algorithm, which can be pre-trained and fine-tuned using 1-class (i.e., all LLIEDs together forming a single class) training and validation datasets.

For the identification of particular LLIED types, a multi-class CNN algorithm based on Inception V3 can be used. Following transfer learning of initial weights derived from the ImageNet dataset to this base CNN, the classification network's final layers can be replaced by a fully connected layer of 1024 nodes in a ReLU activation unit, followed by sigmoid output functions for multi-class classification. The classification network can be further refined using ground-truth ROIs for the multi-class classifier (e.g., a 9-class classifier per specific LLIED type represented in the training and validation dataset for the development of a 9-class LLIED model, or a 12-class classifier per specific LLIED type represented in the training and validation dataset for the development of a 12-class LLIED model, and so on). Any remaining individual training and validation data subset-size imbalances can be rectified through expansions using unique ROI variants generated by traditional image-augmentation techniques (e.g., permutations of ROI vertical flipping, horizontal flipping, width shifting (±20%), height shifting (±20%), channel shifting (±20%), shearing (±20%), zooming (±20%) and rotation (±20 degrees)).

The radiographic image data are then input to the first neural network/model, generating output as LLIED detection/localization data, as indicated at step 306. For example, the LLIED detection/localization data may include feature data or maps associated with the detection and/or localization of LLIEDs within the radiographic image data.

As one example, the LLIED detection/localization data may indicate feature-based AI inferences that correspond to or otherwise indicate the detection/localization of an LLIED in the radiographic image data. In some implementations, the LLIED detection/localization data can include displays of inference results as GBBs that indicate (e.g., visually indicate) the presence and location of LLIEDs in the radiographic image data.

Promoting a prerequisite mandate to detect/localize all LLIEDs and miss none, probability threshold reductions from a standard 0.50 level can be made. A consequential disadvantage of this approach is the potential to produce an excessive amount of GBBs with increased numbers of false positive inference results, and therefore poor positive prediction. In these instances, the likely inference output of large and/or highly asymmetrical GBBs compromising localization can be reduced by filtering the GBBs using a size-restriction filter and/or shape-restriction filter. For example, a filter can be applied to restrict the output-GBB size to 15-120 mm in either dimension with an aspect ratio of 0.7-1.4. Non-max suppression can also be applied to suppress overlapping of GBBs with a specified intersection over union (“IoU”), such as an IoU greater than 0.4.

In some implementations of LLIED detection/localization, a True Positive (“TP”) inference result can be recorded when a GBB overlapped with a ground-truth LLIED-related ROI at IoU>0.5; a False Positive (“FP”) results from a GBB not overlapping at IoU>0.5; and a False Negative (“FN”) results from the failure to create a GBB.

The LLIED detection/localization data are then applied to the second neural network/model, generating output as LLIED identification data, as indicated at step 308. For example, the LLIED identification data may include AI inferences (e.g., feature data or maps) associated with the classification of the specific type(s) of LLIEDs detected within the radiographic image data for LLIED type identification.

With the combined goals of reducing the number of FP results from the LLIED detection/localization and supporting maximal identification of the specific LLIED types, all LLIED detection/localization-related GBBs (i.e., GBBs overlapping with ground-truth ROIs). For the determination of correct LLIED-type identification, correspondence can be confirmed by the label of the GBB that results in the greatest IoU with the ground-truth LLIED-related ROI.

The LLIED detection/localization data generated by inputting the radiographic image data to the first trained neural network, first trained model, first tier of cascading neural networks, or the like; and/or the LLIED identification data generated by inputting the LLIED detection/localization data to the second trained neural network, second trained model, second tier of cascading neural networks, or the like, can then be displayed to a user, stored for later use or further processing, or both, as indicated at step 310.

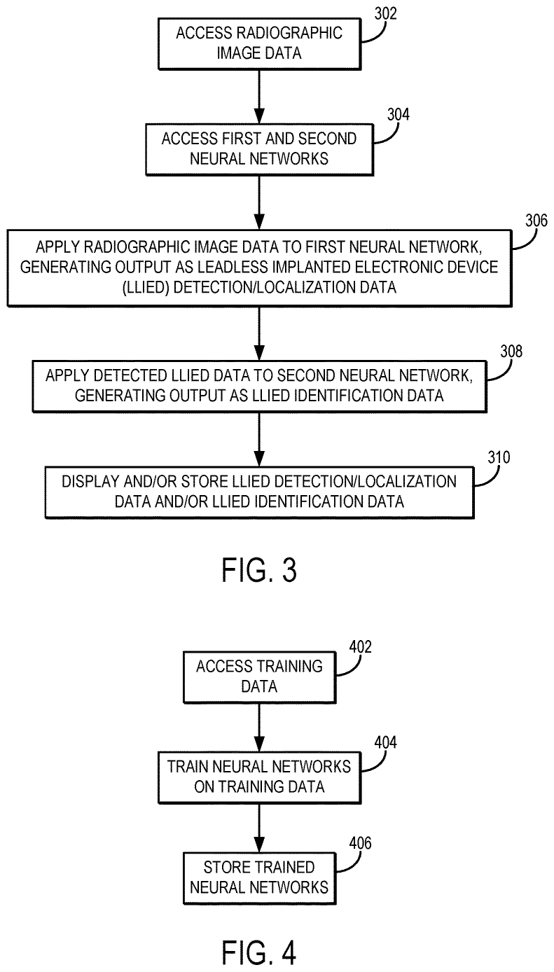

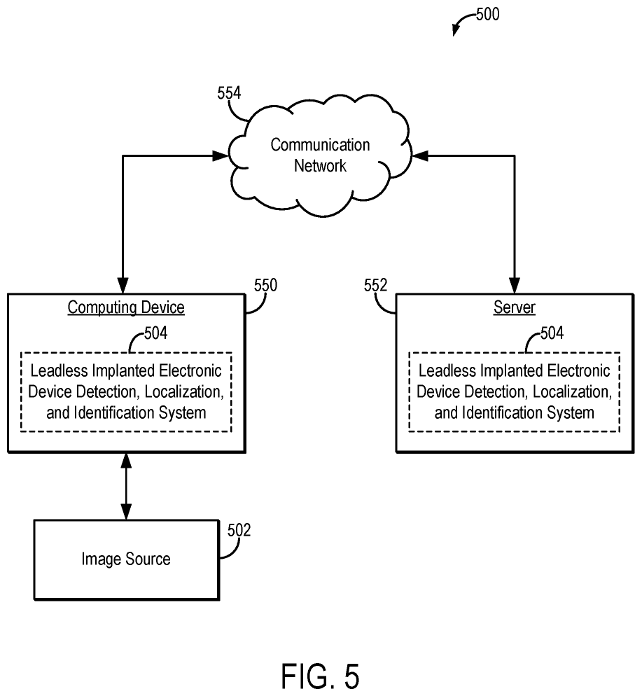

Referring now to FIG. 4, a flowchart is illustrated as setting forth the steps of an example method for training one or more neural networks (or other suitable machine learning algorithms, AI algorithms, or AI models) on training data, such that the one or more neural networks/models are trained to receive input as radiographic image data in order to generate output as LLIED detection/localization data indicating the detected location of LLIED(s) and/or LLIED identification data indicating the identification and/or classification of specific type(s) of LLIEDs detected.

In general, the neural network(s) (or other suitable machine learning algorithms, AI algorithms, or AI models) can implement any number of different neural network/model architectures. For instance, the neural network(s) could implement a convolutional neural network, a residual neural network, and so on. In some instances, the neural network(s) may implement deep learning, in a supervised and/or unsupervised learning fashion.

Alternatively, the neural network(s)/model(s) could be replaced with other suitable machine learning and/or deep learning algorithms, such as those based on supervised learning, unsupervised learning, deep learning, ensemble learning, dimensionality reduction, and so on.

The method includes accessing training data with a computer system, as indicated at step 402. Accessing the training data may include retrieving such data from a memory or other suitable data storage device or medium. Alternatively, accessing the training data may include acquiring such data with an x-ray imaging system and transferring or otherwise communicating the data to the computer system, which may be a part of the x-ray imaging system.

In general, the training data can include radiographic image data (e.g., chest x-ray images or other x-ray images) and expert-identified LLIED ROIs. As a non-limiting example, training data can be collected from subjects demonstrating radiographic evidence of an LLIED, other man-made implants (e.g., retained permanent pacing wires), or foreign objects (e.g., battlefield projectiles, retained surgical items), at some point. The training data may include examinations/ACCs, annotated x-ray images, and LLIED ROIs with various ROI image-quality grades.

In some implementations, the following approach to data distribution can be used: 80% of subjects can be randomly selected to support only training or validation, with the remaining 20% serving to support only testing; and within the training/validation sub-population of subjects, associated x-ray examinations/ACCs can be pooled before being randomly distributed to form the training dataset (e.g., containing 75% of examinations/ACCs) and validation dataset (e.g., containing the remaining 25% of examinations/ACCs). Using this format, ROIs can be distributed per label for specific LLIED type. Individual training and validation dataset-size imbalances can be partially remedied through expansion by utilizing lateral-view ROIs.

Additionally or alternatively, the method can include assembling training data from radiographic image data using a computer system. This step may include assembling the radiographic image data into an appropriate data structure on which the machine learning and/or deep learning algorithm can be trained. Assembling the training data may include assembling radiographic image data, segmented radiographic image data, and/or other relevant data. For instance, assembling the training data may include generating labeled data and including the labeled data in the training data. Labeled data may include radiographic image data, segmented radiographic image data, or other relevant data that have been labeled as belonging to, or otherwise being associated with, one or more different classifications or categories. For instance, labeled data may include radiographic image data and/or segmented radiographic image data that have been labeled to identify the location and type of LLIED in radiographic image data. The labeled data may include data that are classified on a voxel-by-voxel basis, or a regional or larger volume basis.

As a non-limiting example, for radiographic image data annotation reference can be made to data-mined lists (using database and EMR corroboration, as needed) to delineate the specific LLIED types within the Lead-Less Pacemaker (LLP) (2 types, in this example), Lead-Less Recorder (LLR) (5 types, in this example), Pulmonary Artery Pressure Monitor (PAPM) (1 type, in this example), and Esophageal Reflux Capsule (ERC) (1 type, in this example) categories, or other such categories represented in the subject population providing the training data or “real-world” experiences. Based on expert confirmation of the presence of the expected entity, each frontal posterior-anterior (P-A) or anterior-posterior (A-P) chest x-ray or fluoroscopic image demonstrating an LLIED can correspondingly be labeled, such as by using an interactive (positioning, sizing, labeling) color-coded ROI capabilities of a GUI.

In order to expand the data-subset size, provisionally acceptable lateral views can be scrutinized prior to LLIED labeling for possible inclusion in neural network/model development. If a lateral projection of a specific LLIED is considered to be consistent with normal projectional variability on a frontal chest x-ray or fluoroscopic image (e.g., due to differing patient and/or LLIED positioning), it can be appropriately annotated for potential future use in a data subset.

During the placement of ROIs to label one or more of the LLIED types on any chest x-ray image (frontal or acceptable lateral views) or other radiographic image (e.g., fluoroscopic image), a basic quality grade reflecting LLIED general conspicuity and detail clarity can be applied per ROI as follows:

| Grade | Description |
|---|---|
| ID | Unequivocally diagnostic with high device visibility and delineation, |
| | supporting reliable detection/localization and then identification |
| NR | Potentially non-recognizable for detection/localization, moreover for ID, |
| | due to poor device visibility (e.g., from suboptimal radiographic technique |
| | or motion-related blurring) |
| OL | ID, but with superimposed-external or abutting-internal radio-opaque man- |
| | made inorganic objects or with incomplete view inclusion within the |
| | radiographic image margins, causing significant overlapping with |
| | prominent obscuration of device boundaries or internal characteristics |
| NR/OL | Combined NR and OL |

All ROIs, including those with suboptimal grades (i.e., graded NR, OL, or NR/OL), can be included in neural network/model training, validation, and testing processes based on training data.

Additionally or alternatively, assembling the training data may include implementing data augmentation, as noted above. As part of the data augmentation process, cloned data can be generated from the annotated radiographic image data. As an example, the cloned data can be generated by generating variably modified copies of the radiographic image ROIs. For instance, cloned data can be generated using data augmentation techniques, such as adding noise to the original annotated radiographic image data, performing a deformable transformation (e.g., translation, rotation, both) on the original annotated radiographic image data, smoothing the original annotated radiographic image data, applying a random geometric perturbation to the original annotated radiographic image data, combinations thereof, and so on.

Continuous learning and modernization of an AI model towards ongoing real-world adaptation is advantageous for its functionality, and is strongly emphasized by the FDA, as described above. To that end, new LLIED-related data reflecting end-user experience with the deployed cascading neural network methodology since a previous LLIED-model revision (resulting in positively, negatively, modified adjudicated inference-result data and/or the addition of LLEID classes to represent new LLIED types) can be used in the retraining of new versions of the LLIED model by the same methods. As a non-limiting example, this can be used to update a 9-class LLIED model (e.g., a model constructed based on the LLIEDs shown in FIG. 2A) to an updated 12-class LLIED model (e.g., a model constructed based on the LLIEDs shown in both FIG. 2A and FIG. 2B) reflecting the subsequent appearance of three new FDA-approved LLR types in clinical practice, such as those shown in FIG. 2B.

One or more neural networks (or other suitable machine learning or deep learning algorithms) are then trained on the training data, as indicated at step 404. In general, the neural network can be trained by optimizing network parameters (e.g., weights, biases, or both) based on minimizing a loss function. As one non-limiting example, the loss function may be a mean squared error loss function.

Training a neural network (or retraining a neural network for model continuous learning or modernization) may include initializing the neural network, such as by computing, estimating, or otherwise selecting initial network parameters (e.g., weights, biases, or both). Training data can then be input to the initialized neural network or cascading neural networks, generating output as LLIED detection/localization data and/or LLIED identification data for LLIED identification. The quality of the output data can then be evaluated, such as by passing the output data to the loss function to compute an error. The current neural network or combined neural networks (e.g., as with cascading neural networks) can then be updated based on the calculated error (e.g., using backpropagation methods based on the calculated error). For instance, the current neural network can be updated by updating the network parameters (e.g., weights, biases, or both) in order to minimize the loss according to the loss function. When the error has been minimized (e.g., by determining whether an error threshold or other stopping criterion has been satisfied), the current neural network or combined neural networks and the associated network parameters represent the trained neural network.

For both tiers of the cascading neural network methodology, neural network training and validation can be performed using Keras-2.1.440 with TensorFlow-1.15.41, PyTorch, or the like. In a non-limiting example, the initial learning rate can be selected as 0.001 on a stochastic gradient descent optimizer with a batch size of 16, and re-training can be terminated after 100 epochs. During the training and validation process, neural network performance (e.g., monitoring binary cross-entropy) on the validation set can be observed per epoch with preservation of the model of highest performance accuracy to that point. If the validation accuracy increases in subsequent epochs, the current model can be updated.

The one or more trained or retrained neural networks/models are then stored for later use, as indicated at step 406. Storing the neural network(s)/model(s) may include storing network parameters (e.g., weights, biases, or both), which have been computed or otherwise estimated by training or retraining the neural network(s) on the training data. Storing the trained or retrained neural network(s)/model(s) may also include storing the particular neural network architecture to be implemented. For instance, data pertaining to the layers in the neural network architecture (e.g., number of layers, type of layers, ordering of layers, connections between layers, hyperparameters for layers) may be stored.

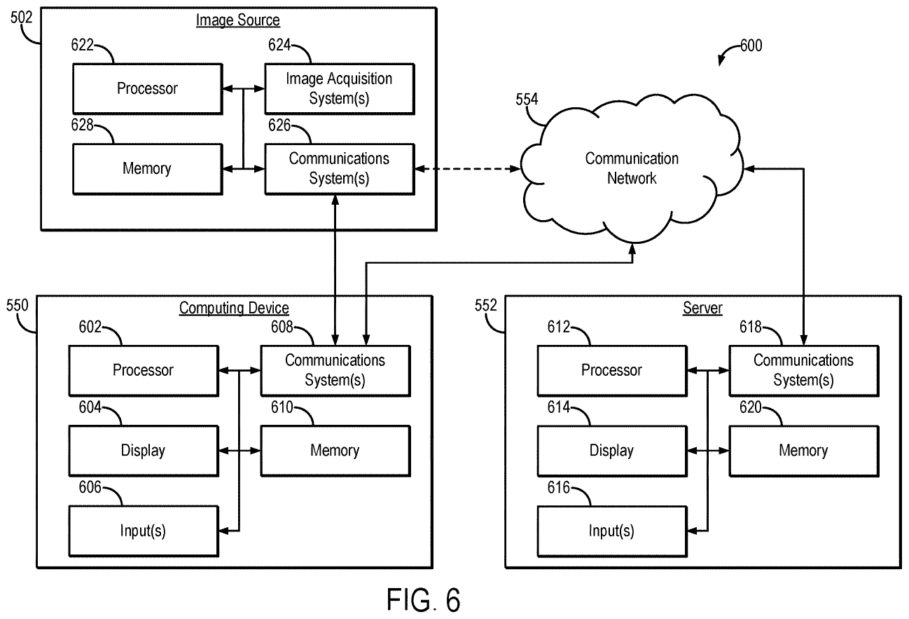

Referring now to FIG. 6, an example of a system 600 for detecting, localizing and/or identifying LLIEDs in medical image data, such as radiographic image data, in accordance with some embodiments of the systems and methods described in the present disclosure is shown. As shown in FIG. 6, a computing device 650 can receive one or more types of data (e.g., radiographic image data) from image source 602, which may be a radiographic image source (e.g., digital x-ray, fluoroscopy). In some embodiments, computing device 650 can execute at least a portion of a leadless implanted electronic device detection, localization, and identification system 604 to detect, localize, and/or identify the type of LLIED from data received from the image source 602.

Additionally or alternatively, in some embodiments, the computing device 650 can communicate information about data received from the image source 602 to a server 652 over a communication network 654, which can execute at least a portion of the leadless implanted electronic device detection, localization, and identification system 604. In such embodiments, the server 652 can return information to the computing device 650 (and/or any other suitable computing device) indicative of an output of the leadless implanted electronic device detection, localization, and identification system 604.

In some embodiments, computing device 650 and/or server 652 can be any suitable computing device or combination of devices, such as a desktop computer, a laptop computer, a smartphone, a tablet computer, a wearable computer, a server computer, a virtual machine being executed by a physical computing device, and so on. The computing device 650 and/or server 652 can also reconstruct images from the data.

In some embodiments, image source 602 can be any suitable source of image data (e.g., measurement data, images reconstructed from measurement data), such as a radiographic imaging system, another computing device (e.g., a server storing image data), and so on. In some embodiments, image source 602 can be local to computing device 650. For example, image source 602 can be incorporated with computing device 650 (e.g., computing device 650 can be configured as part of a device for capturing, scanning, and/or storing images). As another example, image source 602 can be connected to computing device 650 by a cable, a direct wireless link, and so on. Additionally or alternatively, in some embodiments, image source 602 can be located locally and/or remotely from computing device 650, and can communicate data to computing device 650 (and/or server 652) via a communication network (e.g., communication network 654).

In some embodiments, communication network 654 can be any suitable communication network or combination of communication networks. For example, communication network 654 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), a wired network, and so on. In some embodiments, communication network 654 can be a local area network, a wide area network, a public network (e.g., the Internet), a private or semi-private network (e.g., a corporate or university intranet), any other suitable type of network, or any suitable combination of networks. Communications links shown in FIG. 6 can each be any suitable communications link or combination of communications links, such as wired links, fiber optic links, Wi-Fi links, Bluetooth links, cellular links, and so on.

Referring now to FIG. 7, an example of hardware 700 that can be used to implement image source 602, computing device 650, and server 652 in accordance with some embodiments of the systems and methods described in the present disclosure is shown. As shown in FIG. 7, in some embodiments, computing device 650 can include a processor 702, a display 704, one or more inputs 706, one or more communication systems 708, and/or memory 710. In some embodiments, processor 702 can be any suitable hardware processor or combination of processors, such as a central processing unit (“CPU”), a graphics processing unit (“GPU”), and so on. In some embodiments, display 704 can include any suitable display devices, such as a computer monitor, a touchscreen, a television, and so on. In some embodiments, inputs 706 can include any suitable input devices and/or sensors that can be used to receive user input, such as a keyboard, a mouse, a touchscreen, a microphone, and so on.

In some embodiments, communications systems 708 can include any suitable hardware, firmware, and/or software for communicating information over communication network 654 and/or any other suitable communication networks. For example, communications systems 708 can include one or more transceivers, one or more communication chips and/or chip sets, and so on. In a more particular example, communications systems 708 can include hardware, firmware and/or software that can be used to establish a Wi-Fi connection, a Bluetooth connection, a cellular connection, an Ethernet connection, and so on.

In some embodiments, memory 710 can include any suitable storage device or devices that can be used to store instructions, values, data, or the like, that can be used, for example, by processor 702 to present content using display 704, to communicate with server 652 via communications system(s) 708, and so on. Memory 710 can include any suitable volatile memory, non-volatile memory, storage, or any suitable combination thereof. For example, memory 710 can include RAM, ROM, EEPROM, one or more flash drives, one or more hard disks, one or more solid state drives, one or more optical drives, and so on. In some embodiments, memory 710 can have encoded thereon, or otherwise stored therein, a computer program for controlling operation of computing device 650. In such embodiments, processor 702 can execute at least a portion of the computer program to present content (e.g., images, user interfaces, graphics, tables), receive content from server 652, transmit information to server 652, and so on.

In some embodiments, server 652 can include a processor 712, a display 714, one or more inputs 716, one or more communications systems 718, and/or memory 720. In some embodiments, processor 712 can be any suitable hardware processor or combination of processors, such as a CPU, a GPU, and so on. In some embodiments, display 714 can include any suitable display devices, such as a computer monitor, a touchscreen, a television, and so on. In some embodiments, inputs 716 can include any suitable input devices and/or sensors that can be used to receive user input, such as a keyboard, a mouse, a touchscreen, a microphone, and so on.

In some embodiments, communications systems 718 can include any suitable hardware, firmware, and/or software for communicating information over communication network 654 and/or any other suitable communication networks. For example, communications systems 718 can include one or more transceivers, one or more communication chips and/or chip sets, and so on. In a more particular example, communications systems 718 can include hardware, firmware and/or software that can be used to establish a Wi-Fi connection, a Bluetooth connection, a cellular connection, an Ethernet connection, and so on.

In some embodiments, memory 720 can include any suitable storage device or devices that can be used to store instructions, values, data, or the like, that can be used, for example, by processor 712 to present content using display 714, to communicate with one or more computing devices 650, and so on. Memory 720 can include any suitable volatile memory, non-volatile memory, storage, or any suitable combination thereof. For example, memory 720 can include RAM, ROM, EEPROM, one or more flash drives, one or more hard disks, one or more solid state drives, one or more optical drives, and so on. In some embodiments, memory 720 can have encoded thereon a server program for controlling operation of server 652. In such embodiments, processor 712 can execute at least a portion of the server program to transmit information and/or content (e.g., data, images, a user interface) to one or more computing devices 650, receive information and/or content from one or more computing devices 650, receive instructions from one or more devices (e.g., a personal computer, a laptop computer, a tablet computer, a smartphone), and so on.

In some embodiments, image source 602 can include a processor 722, one or more image acquisition systems 724, one or more communications systems 726, and/or memory 728. In some embodiments, processor 722 can be any suitable hardware processor or combination of processors, such as a CPU, a GPU, and so on. In some embodiments, the one or more image acquisition systems 724 are generally configured to acquire data, images, or both, and can include an x-ray imaging system. Additionally or alternatively, in some embodiments, one or more image acquisition systems 724 can include any suitable hardware, firmware, and/or software for coupling to and/or controlling operations of a radiographic (e.g., digital x-ray, fluoroscopy) imaging system. In some embodiments, one or more portions of the one or more image acquisition systems 724 can be removable and/or replaceable.

Note that, although not shown, image source 602 can include any suitable inputs and/or outputs. For example, image source 602 can include input devices and/or sensors that can be used to receive user input, such as a keyboard, a mouse, a touchscreen, a microphone, a trackpad, a trackball, and so on. As another example, image source 602 can include any suitable display devices, such as a computer monitor, a touchscreen, a television, etc., one or more speakers, and so on.

In some embodiments, communications systems 726 can include any suitable hardware, firmware, and/or software for communicating information to computing device 650 (and, in some embodiments, over communication network 654 and/or any other suitable communication networks). For example, communications systems 726 can include one or more transceivers, one or more communication chips and/or chip sets, and so on. In a more particular example, communications systems 726 can include hardware, firmware and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 728 can include any suitable storage device or devices that can be used to store instructions, values, data, or the like, that can be used, for example, by processor 722 to control the one or more image acquisition systems 724, and/or receive data from the one or more image acquisition systems 724; to images from data; present content (e.g., images, a user interface) using a display; communicate with one or more computing devices 650; and so on. Memory 728 can include any suitable volatile memory, non-volatile memory, storage, or any suitable combination thereof. For example, memory 728 can include RAM, ROM, EEPROM, one or more flash drives, one or more hard disks, one or more solid state drives, one or more optical drives, and so on. In some embodiments, memory 728 can have encoded thereon, or otherwise stored therein, a program for controlling operation of image source 602. In such embodiments, processor 722 can execute at least a portion of the program to generate images, transmit information and/or content (e.g., data, images) to one or more computing devices 650, receive information and/or content from one or more computing devices 650, receive instructions from one or more devices (e.g., a personal computer, a laptop computer, a tablet computer, a smartphone, etc.), and so on.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (e.g., hard disks, floppy disks), optical media (e.g., compact discs, digital video discs, Blu-ray discs), semiconductor media (e.g., random access memory (“RAM”), flash memory, electrically programmable read only memory (“EPROM”), electrically erasable programmable read only memory (“EEPROM”)), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

The present disclosure has described one or more preferred embodiments, and it should be appreciated that many equivalents, alternatives, variations, and modifications, aside from those expressly stated, are possible and within the scope of the invention.

1. A method for detecting and identifying a leadless implanted electronic device (LLIED) in an x-ray image, the method comprising:
(a) accessing radiographic image data with a computer system, the radiographic image data including at least one x-ray image of a subject potentially having at least one LLIED;
(b) accessing a first trained neural network with the computer system, the first trained neural network having been trained on first training data to detect and localize a location of a LLIED in radiographic image data;
(c) accessing a second trained neural network with the computer system, the second trained neural network having been trained on second training data to classify a type of LLIED detected in radiographic image data;
(d) applying the radiographic image data to the first trained neural network using the computer system, generating output as LLIED detection data that indicate detecting a presence and a location of the at least one LLIED in the radiographic image data;
(e) applying the detected LLIED data to the second trained neural network using the computer system, generating output as LLIED identification data that identify a type of the at least one LLIED detected in the radiographic image data; and
(f) displaying at least one of the LLIED detection data or the LLIED identification data to a user.

2. The method of claim 1, wherein the LLIED detection data comprise at least one generated bounding box that indicates the location of the at least one LLIED in the radiographic image data.

3. The method of claim 2, wherein step (e) comprises filtering the LLIED detection data before applying the LLIED detection data to the second trained neural network.

4. The method of claim 3, wherein the LLIED detection data are filtered using a filter that restricts at least one of a size or a shape of generated bounding boxes.

5. The method of claim 2, wherein applying the LLIED detection data to the second trained neural network using the computer system also filters generated bounding boxes in the LLIED detection data to identify those generated bounding boxes to be stored in the LLIED identification data.

6. The method of claim 1, wherein step (e) comprises applying both the LLIED detection data and the radiographic image data to the second neural network using the computer system, generating output as the LLIED identification data.

7. The method of claim 1, wherein the first trained neural network comprises a convolutional neural network.

8. The method of claim 7, wherein the first trained neural network comprises a region-based convolutional neural network.

9. The method of claim 1, wherein the second trained neural network comprises a convolutional neural network.

10. The method of claim 9, wherein the second trained neural network comprises a multi-class convolutional neural network.

11. The method of claim 1, wherein the radiographic image data comprise at least one chest x-ray image.

12. The method of claim 1, wherein the first training data and the second training data comprise a single set of training data.

13. The method of claim 1, wherein the at least one of the LLIED detection data or the LLIED identification data are displayed to the user via a user interface of the computer system, wherein the user interface is configured to receive feedback data from the user, wherein the feedback data are indicative of an inference results adjudication based on the user review of the at least one of the LLIED detection data or the LLIED identification data.

14. The method of claim 13, wherein at least one of the first trained neural network or the second trained neural network is retrained based in part on the feedback data.

15. The method of claim 1, wherein the first trained neural network and the second trained neural network comprise a first tier and a second tier, respectively, of a cascading neural network.

16. The method of claim 1, wherein the LLIED identification data include a magnetic resonance imaging safety level for the LLIED.
